(19) United States
(12) Patent Application Publication
(10) Pub. No.: US 2014/0358720 A1
(43) Pub. Date: Dec. 4, 2014

(54) METHOD AND APPARATUS TO BUILD FLOWCHARTS FOR E-SHOPPING RECOMMENDATIONS

(71) Applicant: YAHOO! INC., Sunnyvale, CA (US)

(72) Inventors: Gianmarco De Francisci Morales, Barcelona (ES); Mahashweta Das, Arlington, TX (US); Aristides Gionis, Helsinki (FI); Ingmar Weber, Doha (QA)

(21) Appl. No.: 13/906,589

(22) Filed: May 31, 2013

(51) Int. Cl. G06Q 30/06

(52) U.S. Cl. CPC G06Q 30/0631
USPC 705/26.7

(57) ABSTRACT

An advisor flowchart is built, which flowchart comprises a set of nodes and each node is associated with a user attribute selected from a set of user attributes in a user space, the set of attributes comprising information about users, e.g., lifestyles, interests, demographics, etc. and each node is associated with a ranking of products from a product space. The advisor flowchart may be used to make a set of recommendations available to a user, where the set of recommendations comprise one or more top-ranked products associated with the node at which the user is currently positioned. At each node, the associated user attribute is used to formulate a question that may be posed to the user. The user's answer to the question may be used to progress to another node of the advisor flowchart.

### FIELD OF THE DISCLOSURE

The present disclosure relates to electronic shopping, and more particularly to making recommendations, such as without limitation product recommendations, to users in an electronic, or online, shopping environment.

### BACKGROUND

An online shopping experience differs from a brick-and-mortar shopping experience. More particularly, typically an electronic shopper shops online via a user computer without any human interaction to assist the shopper to identify a product that meets the shopper's needs, while a brick-and-mortar shopper might be able to interact with a retail establishment's employee before purchasing a product. A user's quest to find “the right” product for the user is further hampered by the fact that no human, however expert, can effectively comprehend the entire space of available products, since the catalog of products, particularly online, is vast and is continuously updated. Consequently, shoppers are left without guidance in selecting a product.

### SUMMARY

The present disclosure seeks to address failings in the art and to provide a mechanism to assist an online user in selecting a product, or service, etc., that meets the user's needs. Embodiments of the present disclosure automatically build a flowchart, or flowcharts, that may be used to guide users through a process of identifying a product, service, etc. that meets each user's needs. In accordance with one or more such embodiments, a flowchart maps the user space, which may comprise information about users' lifestyles, demographics, interests, etc., to a product space. By way of a non-limiting example, user attributes may be mapped to attributes of products, services, etc., such that a set of products, services, etc. may be suggested to a user as the user's “best options” given the user's attributes and the attributes of products. In accordance with one or more embodiments, user attributes and product attributes are determined from a training data set, or data sets. Embodiments of the present disclosure learn a particular user's attributes by posing one or more questions, each of which is determined from the flowchart, and receiving the user's answer(s) to the question(s) posed. In accordance with one or more embodiments of the present disclosure, there is no need to have pre-existing knowledge of a user before the user begins using the “shopping advisor,” since information about the user is gleaned from the user's responses and the trained “shopping advisor” flowchart. Thus, embodiments of the present disclosure address the cold-start problem associated with a new user, or a user for which little if any information is known.

Embodiments of the present disclosure use both user preferences and technical product attributes to make recommendations. In accordance with one or more embodiments, user preferences may be elicited via a binary tree-shaped flowchart, also referred to herein as a shopping advisor flowchart, where each node has an associated question designed to illicit information from the user about the user, e.g., the user's preferences, lifestyle, demographics, interests, etc. Each node has an associated ranking of products, from which a set of product recommendations may be suggested that match the preferences of the user. The product rankings may be progressively refined along the path from the root node of the tree to a leaf node of the tree, where they may be some number of internal nodes along the path from the root node to the leaf node. In accordance with one or more embodiments, the questions posed to the user via the flowchart inquire about the user's preferences or user's needs rather than technical attributes of the products. In a training phase, an implicit, or explicit, correlation between user preferences, or attributes, and product attributes is learned and used to build the flowchart, and the learned correlations between user preferences, or attributes, and product attributes may be used to determine product rankings, such that product recommendations may be made at any point along the flowchart.

Embodiments of the present disclosure use a training data to learn a structure of a binary tree-shaped flowchart, including which questions to ask at each node, and produce a ranked, or ordered, set of product recommendations at each node. In accordance with one or more such embodiments, a top-down strategy may be used to build the flowchart, such that a best user attribute is identified as a basis of a question to ask at each node. In accordance with one or more such embodiments, each node of the flowchart partitions the user space, which may result in a partitioning of the product space that is based on the partitioning of the user space. Furthermore and in accordance with one or more such embodiments, a learning to rank approach is used to learn each node of the tree and an arrangement of products appropriate for users that reach the node. Embodiments of the present disclosure guide users in the shopping process, and this focusing provides the user with a positive experience thereby increasing the probability that the user will purchase a product, which increases the conversion rate.

While embodiments of the present disclosure are described with reference to products, it should be apparent that embodiments of the present disclosure are not so limited and may be used to make other types of recommendations, including without limitation recommendations for services, etc.

In accordance with one or more embodiments, a method is provided, the method comprising building, using at least one computer system, an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users; and identifying a set of product recommendations for a user using the advisor flowchart, the at least one computer: traversing the advisor flowchart from a current node to a next node based on an answer received from the user in response to a question formed from the user attribute associated with the current node of the advisor flowchart; wherein the set of product recommendations comprises a number of top-ranked products from the ranking of products associated with an end node of the advisor flowchart.

In accordance with one or more embodiments a system is provided, which system comprises at least one computing device comprising one or more processors to execute and memory to store instructions to build an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users; and identify a set of product recommendations for a user using the advisor flowchart, the instructions to identify comprising instructions to: traverse the advisor flowchart from a current node to a next node based on an answer received from the user in response to a question formed from the user attribute associated with the current node of the advisor flowchart; wherein the set of product recommendations comprises a number of top-ranked products from the ranking of products associated with an end node of the advisor flowchart.

In accordance with yet another aspect of the disclosure, a computer readable non-transitory storage medium is provided, the medium for tangibly storing thereon computer readable instructions that when executed cause at least one processor to build an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users; and identify a set of product recommendations for a user using the advisor flowchart, the instructions to identify comprising instructions to: traverse the advisor flowchart from a current node to a next node based on an answer received from the user in response to a question formed from the user attribute associated with the current node of the advisor flowchart; wherein the set of product recommendations comprises a number of top-ranked products from the ranking of products associated with an end node of the advisor flowchart.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides two examples of tree-shaped flowcharts, one of which poses non-technical user attribute type questions in accordance with one or more embodiments of the present disclosure.

FIG. 2 provides an example of user, product and review tables in accordance with one or more embodiments of the disclosure.

FIG. 3 provides an example of a process flow for learning an advisor flowchart in accordance with one or more embodiments of the present disclosure.

FIG. 4 provides a process flow for using an advisor flowchart in accordance with one or more embodiments of the present disclosure.

FIG. 5 provides an example snapshot of a tree built for advising users about cars in accordance with one or more embodiments of the present disclosure.

FIG. 6 provides examples of some recommendations at three nodes of the decision tree for the advisor flowchart of FIG. 5 in accordance with one or more embodiments of the present disclosure.

FIG. 7 provides an example snapshot of a tree built for advising users about cameras in accordance with one or more embodiments of the present disclosure.

FIG. 8 provide some examples of recommendations associated with various portions of the flowchart of FIG. 7 in accordance with one or more embodiments of the present disclosure.

FIG. 9 illustrates some components that can be used in connection with one or more embodiments of the present disclosure.

FIG. 10 is a detailed block diagram illustrating an internal architecture of a computing device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Certain embodiments of the present disclosure will now be discussed with reference to the aforementioned figures, wherein like reference numerals refer to like components.

The detailed description provided herein is not intended as an extensive or detailed discussion of known concepts, and as such, details that are known generally to those of ordinary skill in the relevant art may have been omitted or may be handled in summary fashion.

In general, the present disclosure includes a system, method and architecture for making recommendations, e.g., product recommendations, that takes into account the user space, which contains user information, e.g., attributes or preferences, such as without limitation demographics, life-style preferences, interests, etc., as well as a product space, including features in a product space, which may contain technical information of the products, for example. In accordance with one or more embodiments, a tree-shaped advisor flowchart is generated. The root and internal nodes of the tree contain questions to be posed to the users. Question may involve information learned from the user space, which questions are easily understood by users, e.g., the users need not be experts in the product area and/or have expertise in the technical aspects of products. By way of some non-limiting example, questions might include “Are you a student?” or “Would you be storing videos in your laptop?” In accordance with one or more embodiments, a user, e.g., a shopper, starts at a question associated with a root node of a tree shaped flowchart and progresses along a path defined by the tree by answering the question(s) posed to the user at each node until the user elects to stop the process or the process reaches a leaf node, where user finds a ranked list of product recommendations. In accordance with one or more embodiments, product recommendations that comprise a ranked list of products is available at each node of the tree, and the user can stop answering at any level in the tree.

In accordance with one or more embodiments, the tree shaped flowchart may resemble a decision-tree, which is learned using a decision-tree learning algorithm and training data, which data comprises information about users and about products to be mapped to users. In accordance with one or more such embodiments, given a set of users with similar features, a ranking may be induced on a full set of products based on the attributes of the products; thus, a tree shaped flowchart may be learned such that a ranking of products may be output at each node of the tree. Users may be partitioned on the basis of user attributes, such that similar users will likely end up at the same tree nodes, since similar user are likely to prefer similar products. Furthermore, the tree provides a ranking of products at each tree node which ranking is done with respect to the technical attributes of the products. In accordance with one or more embodiments, a relationship between user attributes and product attributes may be learned and used to make product recommendations at each node and for a given set of users reaching the node. By way of a non-limiting example, where it is learned that storage capacity of a laptop is an important feature for a particular user segment, this feature may be weighted appropriately and other laptops with large hard disks may be ranked high for this user segment. Embodiments of the present disclosure address new users and new items, thereby alleviating typical cold-start problems.

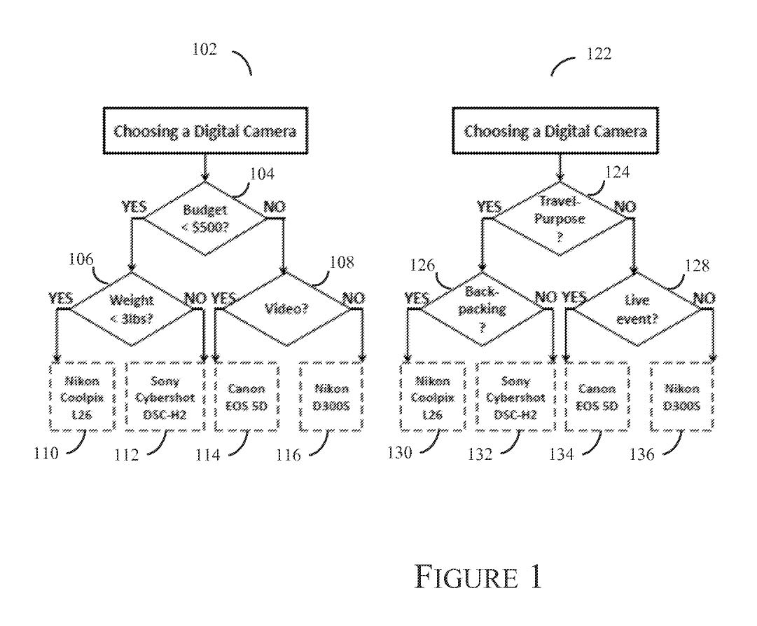

FIG. 1 provides two examples of tree-shaped flowcharts, one of which poses non-technical user attribute type questions in accordance with one or more embodiments of the present disclosure. In FIG. 1, tree-shaped flowchart 122, which poses non-technical user-attribute questions, in accordance with one or more embodiments of the present disclosure is compared with a flowchart that poses technical questions. Flowcharts 102 and 122 both involve choosing a digital camera, and each diamond represents an inquiry, or question, to pose to the user. Looking at flowchart 102, inquiries 104, 106 and 108 are technical in nature, e.g., each of the inquiries relates to a specific attribute of the camera. Following flowchart 102, the user might be asked to identify a price attribute for the camera that the user would like to buy, a weight attribute for the camera and a video capability of the camera, all of which may be difficult for the user to ascertain without some prior knowledge of the various alternatives associated with available camera alternatives.

In contrast to the focus of flowchart 102 on specific attributes of the camera, flowchart 122 has as a focus on attributes of the user, e.g., circumstances in which the user desires to use the camera. More particularly and with reference to flowchart 122, the user is asked whether or not the camera will be used by the user for traveling, e.g., “Do you want a camera for traveling?” If the user responds to the question 124 in the affirmative, the next question according to flowchart 122 relates to whether or not the user plans on using the camera for backpacking trips. If the user responds to the question 124 in the negative, the next question according to flowchart 122 relates to whether or not the user plans on using the camera to take pictures of a live event. Based on the user's answer to question 124 and either question 126 or question 128, the user may be presented with one or more product recommendations. By way of a non-limiting example, an ultra-compact point-and-shoot camera is more likely to be recommended to a user wishing to use the camera for backpacking trips, than a user wishing to use the camera to capture images of a live event.

### Data Mining

In accordance with one or more embodiments, data mining may be used to collect a set of training data, which training data may comprise information about users, products and reviews. By way of a non-limiting example, data mining might be used to extract information from one or more online sources, e.g., Yahoo!™ Autos, which might be mined for information about attributes of cars and of the users, as well as user reviews associated with the cars. By way of further non-limiting example, car specifications as well as ratings and reviews submitted by the users may be collected for the cars. Text-mining techniques might be used to extract tags such as fuel economy, stylish and performance from the reviews, and these tags may be used as user attributes, e.g. each user may be represented by the set of tags that the user has used in the “pros” section of the user's review.

By way of another non-limiting example, data mining might be used to extract information about users and cameras from one or more online sources. To illustrate further without limitation, information about camera users might be collected from an online photo site, e.g., Flickr™, and the tags used by each user to describe the users pictures might be used as a proxy for user interests and lifestyle preferences. Data about the cameras used to take the pictures might also be extracted from tags contained in metadata associated with each picture. Technical specifications of the product, e.g. cameras, might also be mined from various sources, e.g. online databases and/or sites. By way of a non-limiting example, a source for technical specifications and/or expert and/or user reviews, such as CNET™, might be used to collect technical product information, product reviews and/or user information.

In some cases, a popularity measure associated with a product might be used as a proxy for user reviews. By way of a non-limiting example, review scores for cameras used to take pictures are likely not available from a picture uploading website. Metadata, which may be collected from a tag or tags associated with picture(s), typically identifies the camera used to capture the picture, and this information may be used to count how many pictures were taken using a given camera. For example, the higher the number of pictures taken using a particular camera, the greater the popularity is assumed to be for the camera; and this popularity determined from the tag associated with pictures, which popularity for a given camera may comprise a number of pictures taken using the camera, may be used to rank the cameras relative to each other. By way of a further non-limiting example, metadata information indicating a picture's subject coupled with metadata information identifying the camera used to capture the subject might be used to identify which cameras users prefer to use to capture a particular subject and/or which cameras users do not prefer to use to capture the subject. Metadata and/or picture content may be extracted and used to determine how each camera is being used, e.g., determine that a given camera, or cameras, is/are being used to capture wilderness or outdoor scenes, live events, etc. To further illustrate without limitation, where information extracted from the metadata of a number of pictures identifies a subject captured in the picture to be food, the camera(s) used to capture these pictures may also be extracted and used to identify a preference for one or more cameras, or lack thereof, in taking pictures of food. In one non-limiting example, information was extracted from 3000 photographs tagged “food”, of which 40% were taken with either a Canon EOS 20D, a Canon EOS 350D, a Canon EOS 400D or a Nikon D80, while 550 other different cameras were used for the remaining 60%; a user preference for these four cameras when taking pictures of food may be inferred from this data.

User, Product and Ratings Data

Embodiments of the present disclosure may store data to be used to build an advisor flowchart in multiple data tables, e.g., a user table, U, a product table, P, and a reviews table, R. The user table. U, comprises information about the users and may have dimensions of n_{U}×m_{U}, where n_{U} represents the number of users about which information is collected and m_{U} represents the number of attributes collected about each user. By way of a non-limiting example, user information may be supplied by the user, e.g., when the user registers for an application, user comments and/or reviews, and/or information obtained by implicit activity of the user, such as tags provided to social-media sites, browsing behavior, online purchasing behavior, etc. In accordance with one or more embodiments, explicit and/or implicit information may comprise information from which interests and lifestyle preferences of the users may be determined. Herein, a notation uᵢ used to refer to the i^{th} user.

In accordance with one or more embodiments, the product table, P, may have dimensions of n_{P}×m_{P}, where n_{P} is the number of products about which information is collected and m_{P} is the number of technical attributes collected about each product. By way of a non-limiting example, attributes related to cameras may comprise information such as resolution, zoom, aperture, weight etc. Herein, a notation pⱼ is used to refer to the j^{th} product.

In accordance with one or more embodiments, the reviews table, R, may have dimensions n_{C}×3 where each row describes a reviewing action (uᵢ, pⱼ, sᵢⱼ), such that the row comprises data about user, uᵢ, evaluating product, pⱼ, and a score sᵢⱼ. By way of a non-limiting example, sᵢⱼ may be a number in an interval, e.g., sᵢⱼε[1, 5] where sᵢⱼ=1 reflects a negative opinion and sᵢⱼ=5 reflects a positive opinion. By way of a further non-limiting example, the score may be explicitly provided by the user or it may be inferred from commentary provided by the user.

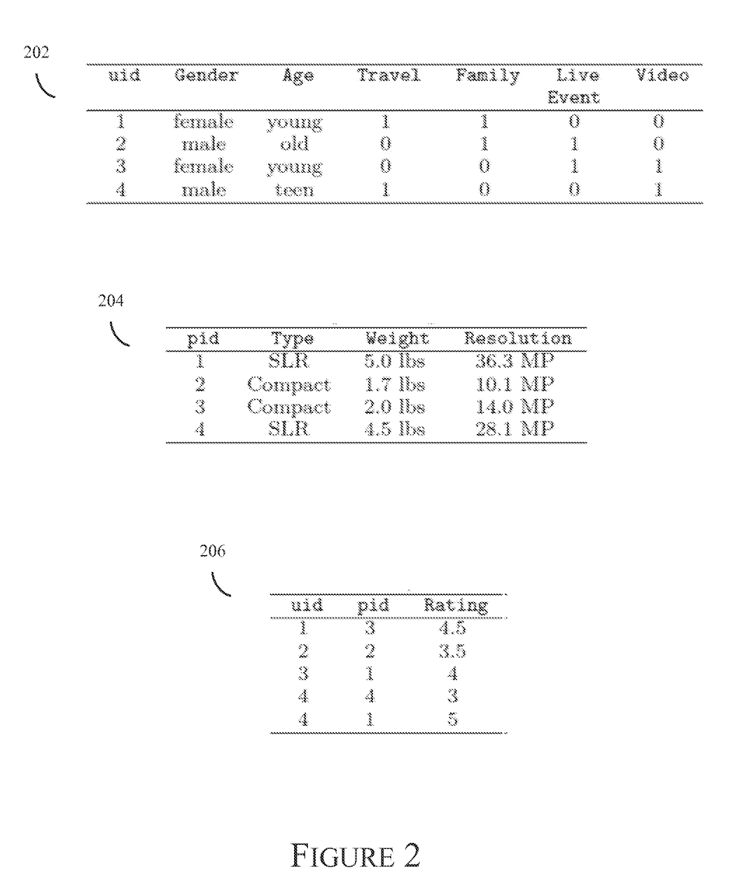

FIG. 2 provides an example of user, product and review tables in accordance with one or more embodiments of the disclosure. More particularly. FIG. 2 provides an example of user table 202, product table 204 and review table 206. In the example shown in FIG. 2, user table 202 comprises a unique user identifier field uniquely identifying a user, together with fields comprising information about the user, such as and without limitation demographic information, such as without limitation the user's gender and age information, and fields comprising the user's interest and/or lifestyle information, such as without limitation travel, family, live event and video information. By way of a non-limiting example, the user's interest(s) and/or lifestyle information may be in the form of binary information, where the user corresponding to uid=2 is not interested in traveling or video (e.g., taking video), has a family and is interested in live events.

Product table 204 comprises a unique product identifier field, pid, uniquely identifying a product, together with fields identifying technical attributes of the product. In the example shown in FIG. 2, product table 204 comprises information about four different cameras, including camera type, such as without limitation compact or SLR, weight and resolution. User review table 206 comprises a user identifier, or uid, field corresponding to the uid field in the user table 202, a product identifier, or pid, field corresponding to the pid field in the product table 204, and a rating field, which stores a score associated with a product and user. In the third row of user review table 206, for example, the young female user that is interested in live events and video gave the SLR camera in the first row of the product table 204 a rating of 4, e.g. a positive rating. By way of a non-limiting example, the information in the third row of user review table 206 might be generalized for all users or users who are also young females having an interest in live events and capturing video, such that the SLR camera in row one of the products table 204, or another camera having the same or similar attributes, might be preferred by users with similar interests, lifestyles and demographics. By way of further non-limiting example, rather than asking a user to identify particular technical attributes of cameras, embodiments of the present disclosure might ask questions regarding a user's interests in travel, live events, video and/or family to identify whether or not to recommend an SLR camera such as that identified in the first row of product table 204 to the user.

Herein, a set of products may be denoted as P, a set of users may be denoted as L and a set of user attributes may be denoted as A, where the number of products, n_{P}, in a product set, P, may be denoted as |P|=n_{P}, the number of users, n_{U}, in a user set, U, may be denoted as |U|=n_{U} and the number of user attributes, m_{U}, in an attribute set, A, may be denoted as |A|=m_{U}.

Decision Tree

A decision tree may be generated collected training data, e.g., mined data, in accordance with one or more embodiments. Herein, a decision tree built in accordance with one or more embodiments is synonymous with an advisor flowchart, and be denoted as T. Internal nodes of the tree, T, correspond to user attributes in A. In accordance with one or more embodiments, tree T may be used to define a flow by which a user receives product recommendations. Initially, the user may start at the root of the tree, T. Each internal node, including the root node, of a tree, T, has an associated user attribute, denoted by a where aεA, and the user attribute, a, may be presented to the user in the form of a question. By way of a non-limiting example, if a is a demographics attribute, the question might be “Are you in the a demographics group?” While if a is an interest or lifestyle attribute, the question might be “Are you interested in tag a?” The user, by answering a question associated with a current internal node, e.g., which might initially be the root node of tree T, follows either the left or right subtree from the node, and the decision process progresses recursively as the user answers questions corresponding to internal nodes of tree T until the user reaches a leaf node or the user decides to stop answering further questions. Where the user elects to stop answering further questions at an internal node, the user may be presented with a set of product recommendations comprising one or more products in accordance with a product ranking, or ordering, associated with the node.

Leaf nodes of tree, T, may correspond to an ordering of the products in the product set, P. Where a user reaches a leaf node, l, where lεL and L is a set of nodes, by following internal nodes of tree T and answering questions, according to at least one embodiment of the present disclosure, as set comprising at least one product recommendation is made available to the user, where the set of recommendations comprises one or more products having an order specified by the leaf node, l. By way of a non-limiting example, a set of recommendations may comprise some number, k, of the top products in the ordering, and the user may have the ability to request one or more additional sets of recommendations, e.g., by selecting a “next k products” button, following the product ordering associated with a given node, e.g., leaf node l.

Decision Tree Generation

In accordance with one or more embodiments, the decision tree, T, is generated using input that includes a product table, P, a review table, R, a user table, U, and integers h and k, where h denotes the height of the tree and k denotes a number of top-ranked products of the set products P to be presented in an ordered list to the user at a given node. As discussed herein, each internal node of the tree contains a question formed given the user attribute a corresponding to the internal node, and each tree node contains a top-k ranked list of products selected from the product set P. In accordance with one or more embodiments, a user begins at the root node, answering some number of questions, and where the user continues answering questions until the user reaches a leaf node the user may be presented with a set of recommendations comprising the top-k recommendations associated with the leaf node.

In accordance with one or more embodiments, to build an advisor flowchart, a machine-learning approach may be followed, which uses cross validation. By way of a non-limiting example, the training data may be split into ten partitions, nine of which may be used to build the advisor flowchart, or learned model, and the remaining partition may be used to evaluate, or validate, the learned model. This process might be repeated a number of times, e.g., ten times, by identifying a different partition to be the evaluation, or validation, partition. The user reviews in the evaluation partition may be used to evaluate recommendations output by traversing the decision tree generated using the data from partitions used to train the model. Information retrieval measures may be used in evaluating the quality of a ranked list.

In accordance with one or more embodiments, the structure of the decision tree, T, may be learned by partitioning the set of users in the training set recursively on the basis of available user attributes, e.g., demographics, tagging behavior, lifestyle preferences, etc., and matching a test user to the leaf node of users with whom the test user shares her preferences. For each group of users, product attribute weights may be learned and a ranking of top-k products in the training data set may be generated, in order to identify the top products for recommendation.

In general, the tree, T, may be constructed in a top-down fashion, where each internal node splits the users in the training data into two or more subspaces according to the output of a function that is evaluated on the input data.

In accordance with one or more embodiments, a decision tree, T, may be built such that for each node of the tree a user attribute associated with node may be identified to partition the set of users active at that node, and a ranking of products to recommend to users at that node may be identified. More particularly, each internal node of a tree, T, corresponds to the set of users whose attributes match the attributes of all internal nodes on the path from the root node of the tree to the current node. Thus, the set of users may be recursively partitioned at each internal node using a partition criteria such that the users on each side of the split agree on the rankings of products. A goal is to select a user attribute at the node so that the split that is performed at the node based on selected attribute uniformity criterion on the user ratings is maximized. By way of a non-limiting example, if it happens that avid hiker's tend to prefer a certain camera, for its weight, ruggedness and ability to take high-quality outdoors photos, then a hiking tag may be used to split the active users at that point in the construction of the tree, T.

In addition to selecting an attribute to associate with an internal node, embodiments of the present disclosure determine a ranking of products at each node, which node may be an internal node or a leaf node. In accordance with one or more embodiments, a ranking of products at a node may be determined from a learning-to-rank model that uses the ratings of the users' belonging to that node. For purposes of illustration and without limitation, assume that a user has followed the branch(es) of the tree, T, to a node, q. If the node, q, is a leaf node, the user is provided with a top-k list of products as a set of recommendations. If the node, q, is an internal node, the user is asked the question that corresponds to the internal node at which the user is positioned, and depending on the user's answer the user proceeds to one of two sub-trees of q. During the evaluation phase, e.g., a phase evaluating a generated tree, it is assumed that a user navigates until the user reaches a leaf node. In application once a tree is learned and evaluated, a user may be given an opportunity to decline answering the question associated with node, q, and to receive a set of recommendations at node, q.

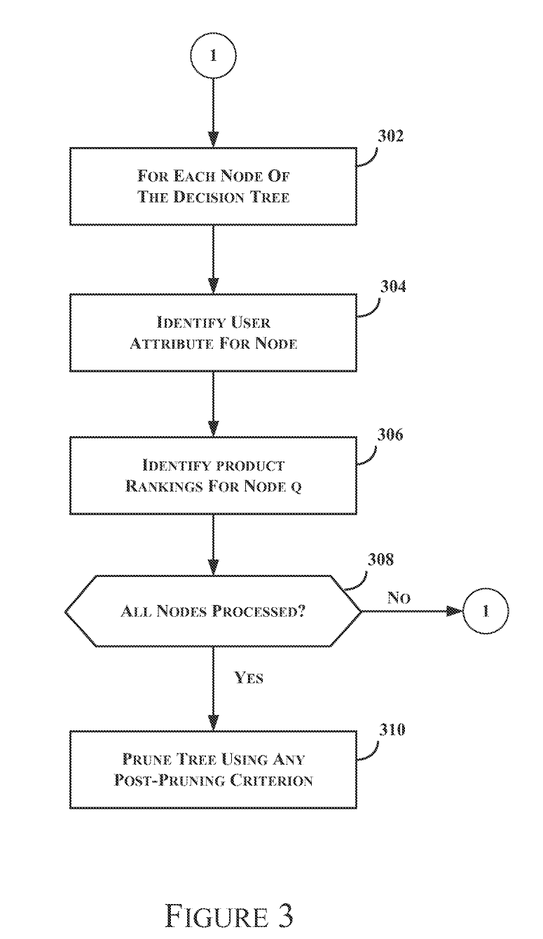

FIG. 3 provides an example of a process flow for learning an advisor flowchart in accordance with one or more embodiments of the present disclosure. Briefly, an advisor flowchart generation comprises learning a tree structure, including determining a user attribute at each node, q, of the tree, T, to use in an inquiry to be posed to the user reaching the node, and learning which products and a ranking of products in product set, P, to associate with the given node, q, of the tree.

With reference to FIG. 3, a structure of a decision tree step is determined, or learned, for each node, q, of the decision tree, or advisor flowchart, as indicated by step 302. For each node, q, an attribute from the set of user attributes, e.g., where aεA, is identified and associated with the node, at step 302. The attribute, a, associated with a given node, q, is used in the form of a question to be posed to user reaching the given node.

By way of a non-limiting example, assume a tree node, q, and a set of users U_{q} responding to a question posed using the user attribute associated with the node, namely, the set of users whose attributes match the attributes of all internal nodes on the path from the root of the tree to node, q. Given a candidate attribute, or splitting user attribute, a, where aεA, two subsets of U_{q} are defined: the set of users U_{q}(a) who match attribute a, and the set of users U_{q}(ā) who do not match attribute a. By way of a non-limiting example, it may be that U_{q}=U_{q}(a)∩U_{q}(ā) and that U_{q}(a)∩U_{q}(ā)=0, although it is not required as overlapping subsets are possible and may be accommodated in the advisor flowchart. In accordance with one or more embodiments, the root node of the tree comprises n_{U} users, e.g., the set of all users, included a user table U.

In accordance with one or more embodiments, a payoff function may be used to determine the best user attribute, a, where aεA, to split the set of users U_{q} at tree node, q. The payoff function may be evaluated using the set of users resulting from the split. More particularly, a combine function, combine, may be considered that match the payoff of the two subsets to a single valued measure, which may be expressed as follows:

payoff(q,a)=combine(payoff(U_{q}(a)),payoff(U_{q}(ā)),|U_{q}(a)|,|U_{q}(ā)|,|U_{q}|) Expr. (1)

where the function payoff(U) evaluates the quality of ranking induced by a set of users, U, and where the set of users U may be the set of users U_{q}(a) who match attribute a or the set of users U_{q}(ā) who do not match attribute a. Expression (1) determines a payoff of splitting node, q, using user attribute, a, and a combine function, which uses the set of users U_{q}(a) who match attribute a, and the set of users U_{q}(ā) who do not match attribute a, the number of users in the set of users active at node q, U_{q}, and the number of user in sets U_{q}(a) and U_{q}(ā). By way of some non-limiting examples the combine function might be a sum, arithmetic, geometric mean, harmonic mean, etc. In accordance with one or more embodiments each possible user attribute aεA may be considered to form the split and the attribute aεA selected may be the one that maximizes the payoff, e.g., the payoff determined using the payoff function of Expression (1). This may be expressed as follows:

splitter(q)=arg max payoff(q,a). Expr. (2)

By using such a posterior goal of maximizing payoff, the set of users may be partitioned into two groups, each of which has similar preferences and which rank the available products in product set, P, in a similar manner. Furthermore, hidden correlations among the set of user attributes in the set of product attributes may be leveraged. By way of a non-limiting example, using a previous example of hikers preferring certain lightweight cameras, a decision tree may learn the fact that the weight of the camera is an important feature for that specific subset of the population of users, and thus it may tend to rank lightweight cameras higher even where the lightweight cameras have not been explicitly rated.

In accordance with one or more embodiments, a recursive algorithm is used to build the advisor flowchart, such that the structure of the flowchart's decision tree is by partitioning the set of users in the training data set recursively on the basis of available user attributes. In accordance with one or more such embodiments, the recursive algorithm is an instantiation of a greedy heuristic.

Referring again to FIG. 3, learning to rank the products in product set, P, at a given tree node, q, is performed at step 306. As input, a set of users, U_{q}, corresponding to node, q, is used, together with information from product table P and review table R. In accordance with one or more embodiments, it is only necessary to consider the rows of the review table R that correspond to the users U_{q}, which represents the set of users active at node, q. The portion of R, or the sub-table of R, corresponding to the users U_{q} may be expressed as R_{q.}

In accordance with one or more embodiments, a function, rank: P→ [symbol] , which given a product, p, where pεP, returns a value rank(p), may be used to induce a ranking on the products in the product set, P. In accordance with one or more embodiments, a linear function may be used, and weight coefficients may be used for the product attributes, which weight coefficients may be based on the scores found in R_{q}. In accordance with one or more embodiments, categorical attributes of products may be converted into a set of Boolean attributes which may be treated as numerical 0, 1 values.

In accordance with one or more embodiments the function, rank, may be any learning-to-rank algorithm, such as and without limitation Regression, RankSVM, Gradient-Descent, etc. The score may be assigned to each product, p, in product set, P, by way of some non-limiting examples, the score may be computed as the average rating of P in the review table R_{q}, e.g., an average rating of P over the set of users who are active at the tree node, q, under consideration.

Learning the tree structure and learning the product rankings may interact with each other. The ranking function that is learned at a tree node may depend on the set of users, and their ratings on products, who correspond to the tree node. This interaction, or dependence, may be expressed as rank_{U} to illustrate that a dependence of the ranking function on a set of users U may exist. The quality of a ranking may be evaluated using a quality measure, which is referred to herein as eval. Functions such as precision, recall, normalized discounted cumulative gain (NDCG), and mean reciprocal rank (MRR) are some non-limiting examples of functions that may be used as eval functions. The quality of a rank_{U} ranking measured by an eval function may be expressed as eval(rank_{U}), for example.

As discussed herein, in accordance with one or more embodiments, a user attribute may be determined to be a good candidate user attribute to be used to split a tree node, q, where the user attribute induces sub-populations with good rankings in each one of the sub-populations, e.g., sub-populations U_{q}(a) and U_{q}(ā). The quality of the ranking may be reflected in the payoff function used for splitting, such that:

payoff(U)=eval(rank_{U}) Expr. (3)

In the above expression, the function payoff(U) equates to an evaluation of the quality of the ranking induced by a set of users.

In accordance with one or more embodiments, a weighting is assigned to each technical attribute of products in the product set, P. The weightings may be expressed as a weight vector, w, wherein w={w₁, . . . , wₘ_{_{P}}} for the m_{P} technical attributes of the products in product set, P. In accordance with one or more embodiments, a learning-to-rank algorithm may be applied to each tree node, q. By way of a non-limiting example, assume that tree node, q, has a set P_{q} of training instances, which are a subset of products of product set, P, accompanied with review scores from the user's associated with the node, q. The training instances may be the result of joining the product table P with the review sub-table R_{q}. A pairwise RankSVM method may be used to learn the ranking function rank. Namely, ordered pairs of products (pᵢ, pⱼ) may be created, where the product, pᵢ, has a higher score than the product pⱼ from the users in the tree node, q. The set of such order pairs may be denoted by P_{q}². The weight vector, w={w₁, . . . , wₘ_{_{P}}}, may be determined by optimizing a pairwise objective function, such as and without limitation:

$$\{ \frac{λ}{2} {‖ w ‖}^{2} + {\sum }_{( {p}_{i} , {p}_{j} ∈ {P}_{q}^{2} )}^{ } loss ( {w}^{T} \cdot ( {p}_{i} - {p}_{j} ) ) \} , \qquad Expr . ( 4 )$$

where loss is a suitably-defined loss function such as hinge loss, or loss (y)=max (0, 1−y) and w^{T} is a transposition of w. For the class of linear ranking functions, the objective of obtaining an optimal ranking function rank*, i.e., finding that weight vector w so that the number of discordant pairs is minimized is NP-hard, and the RankSVM algorithm provides an appropriate solution. Once the weight vector is learned, the rank function is defined as rank(p)=w^{T}·p, and induces a ranking on the set of products P by rank(p₁)≧ . . . ≧rank (pₙ_{_{P}}).

By virtue of learned ranking performed in accordance with one or more embodiments, popular products belonging to the training instances for the users of node, q, may be promoted, and all products may be ranked, including products that have not been reviewed by the set of users in node, q. Furthermore, by virtue of the automatic relationships formed between user attributes and product attributes using RankSVM in accordance with one or more embodiments, the cold-start problem may be addressed.

A quality of the ranking, rank(p₁)≧ . . . ≧rank(pₙ_{_{P}}) on the products in P, which results from a learning-to-rank model described above may be evaluated, or measured, by an eval function. In accordance with one or more embodiments, an eval function may measure the number of correctly-ranked pairs in the ranking generated for the products in P_{q}, i.e. the products in the training set at node, q. The following provides an example expression of an eval function where the set P_{q} contains n products:

$$eval ( rank ) = \frac{2 \vert \{ ( {p}_{i} , {p}_{j} ) ∈ {P}_{q}^{2} \vert rank ( {p}_{i} ) > rank ( {p}_{j} ) \} \vert}{n ( n - 1 )} \qquad Expr . ( 5 )$$

In accordance with one or more embodiments, a choice of the eval function may stem from the RankSVM approach. Similarly, use of sum as the combine function, e.g., summing the number of correctly-ranked pairs, is guaranteed by RankSVM that the eval function is monotonically increasing with the height of the tree. Effective pruning strategies may therefore be used while building the tree.

With reference to FIG. 3, at step 308, a determination is made whether or not the decision tree is generated, e.g., all nodes have been processed for inclusion in the decision tree. If not processing continues at step 302 to add a new node to the decision tree, e.g., identify an attribute and product ranking for the new node. By way of a non-limiting example, the process of building the tree, e.g., the process flow FIG. 3, may stop recursively partitioning the subspaces along one or both directions of the tree if a perfect ranking is achieved in the left and right children nodes, e.g., the payoff associated with splitting by attribute a for node q is 0. At step 310, where it is determined, at step 308, that decision tree generation tree is complete, e.g., the decision tree is built, or grown, to its entirety, a post-pruning process may be used to remove sections of the tree determined to provide little power to capture user preferences. By way of a non-limiting example, for a node q split by tag travel, if it's child node is split by tag vacation, or some other tag which is synonymous with travel, post-pruning rules may trim the child node, or the associated set of nodes. In accordance with one or more embodiments, pruning rules may be employed on the validation set. In accordance with one or more embodiments, a stopping condition, which may be in addition to regular rules, may result from the following:

Theorem 1. The number of inversions due to a ranking model on a set of training instances belonging to a node monotonically decreases with the decrease in size of the training set along the route-to-node path.

Decision Tree Examples

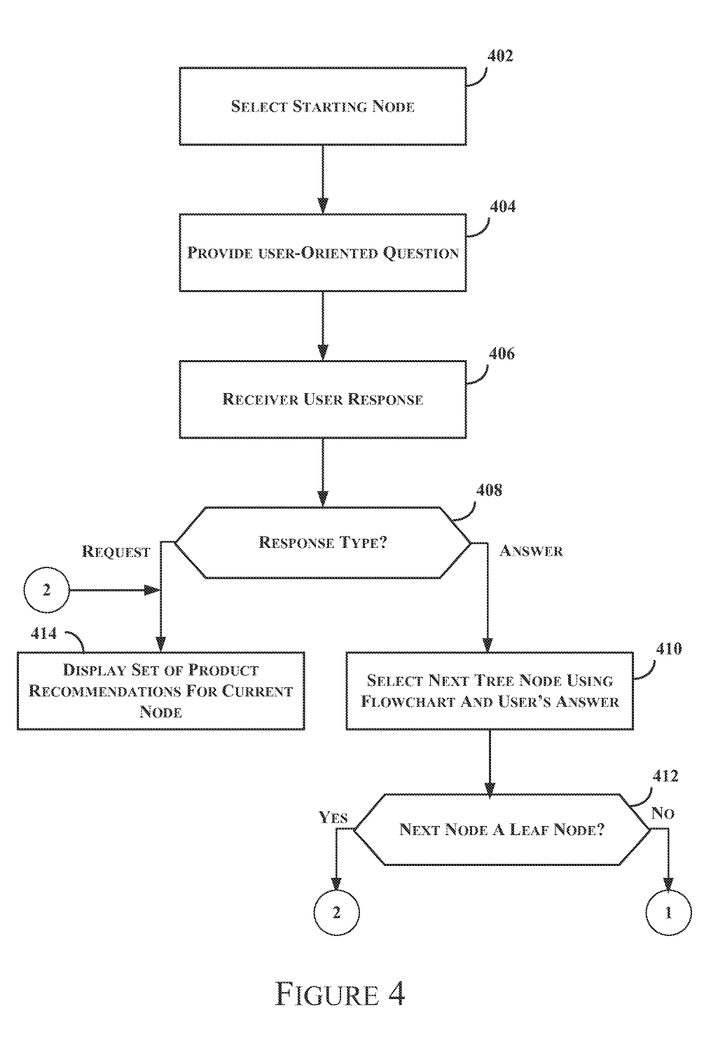

FIG. 3 provides an example of building an advisor flowchart. FIG. 4 provides a process flow for using an advisor flowchart in accordance with one or more embodiments of the present disclosure. In accordance with one or more embodiments, the advisor flowchart may be a shopping advisor flowchart that uses responses to user-oriented questions, such as without limitation questions about the user's interests, lifestyle, demographics, etc., to identify a set of product recommendations for the user.

At step 402, a starting node is selected. By way of a non-limiting example, the starting node may be the root of the decision tree, or shopping advisor flowchart. By way of another non-limiting example, the starting node may be a node at which the user left off in a previous session. As described herein, a user may be provided with a set of recommendations where the user reaches a leaf node of the tree and/or where the user indicates a desire to be presented with a set of recommendations at another, internal node, such as where the user elects to finish the inquiry prior to arriving at a leaf node. Thus, a user might elect to receive a set of recommendations at a current non-leaf node, and return later to continue or complete the process to a leaf node.

At step 404, the user is presented with a user-oriented question associated with the node selected at step 402. By way of some non-limiting examples, the question may be based on one of the attributes identified for users in the user space, e.g., the question might relate to the user's lifestyle, demographics, interests, etc. At step 406, a response is received from the user. The response may be a request for product recommendations or an answer to the question provided for the user to provide an answer in response at step 404.

In a case that the response is an answer to the question posed, processing continues at step 410 to select the next tree node indicated by shopping advisor flowchart, e.g., the advisor flowchart generated using the process described with reference to FIG. 3 above. At step 412, a determination is made whether the next node is an internal node or a leaf node. If the next node is an internal node, processing continues at step 404 to pose another question determined from the user space to the user. If the next node is a leaf node, processing continues at step 414 to display a set of product recommendations, e.g., a top-k ranked number of product recommendations associated with the leaf node.

If it is determined, at step 408, that the user response was not a response to the question but a request for a set of product recommendations, processing continues at step 414 display the set of recommendations associated with the current node, e.g., a top-k ranked number of product recommendations associated with the current node.

The following provides two examples of portions of advisor flowchart decision trees built from training data sets involving two different types of products, e.g. cars and cameras.

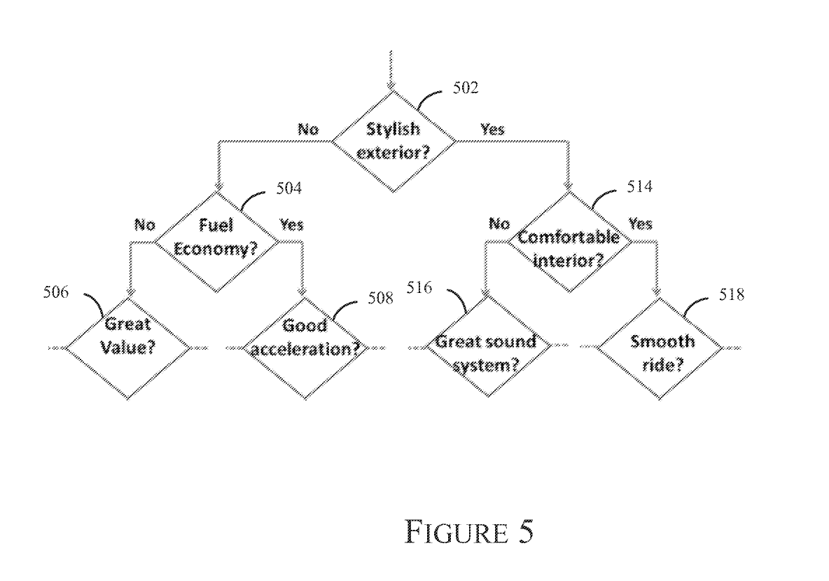

FIG. 5 provides an example snapshot of a tree built for advising users about cars in accordance with one or more embodiments of the present disclosure. Each decision block 502, 504, 506, 508, 514, 516 and 518 correspond to a node in a decision tree built in accordance with one or more embodiments of the present disclosure, and each node has a corresponding attribute intended to split the active users at the node into separate sub-populations of users, e.g., two sub-populations of users, and ranking of products.

At step 502, for example, the attribute relates to the exterior of the car, e.g., the stylishness of the car's exterior. At step 502, the user is asked if she would like to buy a stylish car. Thus, the user population is split into two sub-populations, e.g., those users that wish to buy a car based on the car's stylishness and those users for whom stylishness is not an important basis in deciding on which car to buy. In the example, the question at step 502 splits the users between those users interested in the technical aspects of the car, e.g., fuel economy, good acceleration, great value, etc. and those users interested in the aesthetics of the car, e.g., comfortable interior, great sound system, smooth ride, etc. If the user answers “yes” to the question associated with step 502, the next question posed to the user, at step 514, which relates to the interior of the car. If the user answers “no” to the question associated with step 502, the next question posed to the user, at step 504, relates to the fuel economy of the car.

To further illustrate without limitation, if the user indicates that she is interested in a stylish exterior in response to the question at step 502 but does not express a requirement for a comfortable interior, at step 514, the user is asked if she is interested in a great audio system inside the car, at step 516. On the other hand, a user who indicates that she is not interested in a stylish exterior, at step 502, is presented with a question regarding the user's interest in fuel economy, at step 504. Where the user indicates that she is interested in a car that has good fuel economy, the user is presented with a question to determine if acceleration is important to the user, since fuel-efficient cars typically have slower acceleration. Where the user indicates that she is not interested in fuel economy, at step 504, the user is asked to indicate her interest in getting a great value when buying a car, at step 506. In the example shown in FIG. 5, steps 506, 508, 516 and 518 might correspond to leaf nodes.

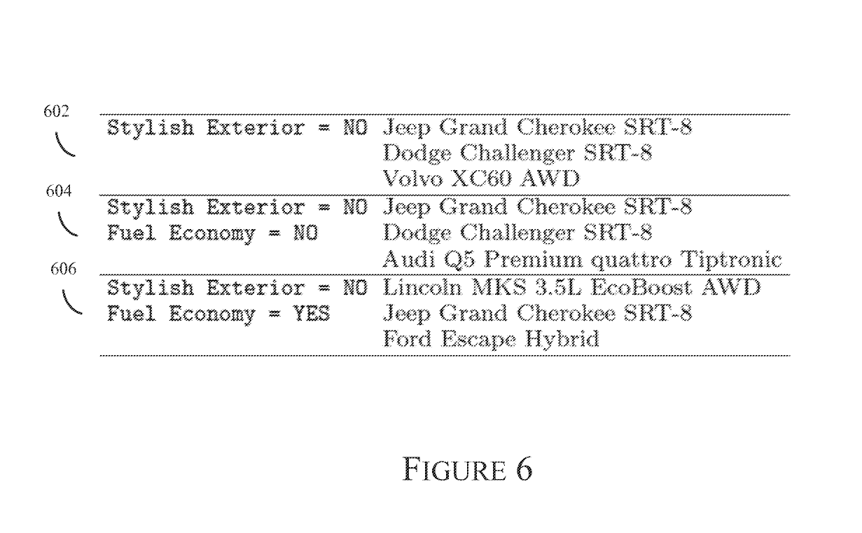

As discussed herein, in accordance with one or more embodiments, each node of the decision tree has a product ranking in addition to an associated attribute. FIG. 6 provides examples of some recommendations at three nodes of the decision tree for the advisor flowchart of FIG. 5 in accordance with one or more embodiments of the present disclosure. Each of recommendations 602, 604 and 606 provide some top-ranked cars that may be presented to the user at various points along advisor flowchart. To illustrate without limitation, recommendations 602 are associated with node 514 and might be presented to a user that has indicated that she does not consider a stylish interior to be important at node 502; recommendations 604 are associated with node 506, and might be presented to a user that has indicated that she does not consider a stylish interior and fuel economy to be important at nodes 502 and 506, and considers acceleration to be important, e.g., stylish exterior, and 504, e.g., fuel economy; and recommendations 606 are associated with step 508, e.g., for a user that has indicated that fuel economy is important to the user. In the example of FIG. 5, it is observed that inclusion of the fuel economy condition brings in a hybrid car and an ecoboost car in the top recommendations, while exclusion of requirements of the fuel-efficient car results in an Audi, which is known to compromise mileage for performance, being included in the set of recommendations; and, the presence of the Jeep Grand Cherokee SRT-8 at all three nodes is indicative of the popularity of the car in the year in which the training data was collected.

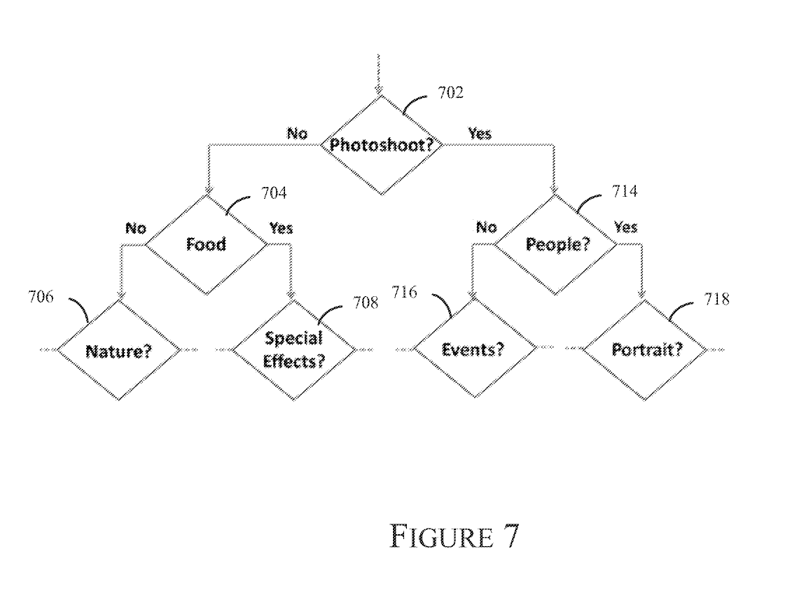

FIG. 7 provides an example snapshot of a tree built for advising users about cameras in accordance with one or more embodiments of the present disclosure. Each decision block 702, 704, 706, 708, 714, 716 and 718 corresponds to a node in a decision tree built in accordance with one or more embodiments of the present disclosure, and each node has a corresponding attribute and ranking of products. In the example of FIG. 7, the user is asked if she is interested by a camera for photo-shoot purposes, and where the user responds in the affirmative, the user is asked whether or not she is specifically focusing on face shots. As can be seen, the flowchart in FIG. 5, like the flowchart in FIG. 5, focuses on the preferences of the user. In the example of FIG. 7, the advisor flowchart makes camera recommendations tailored to the user's preferences.

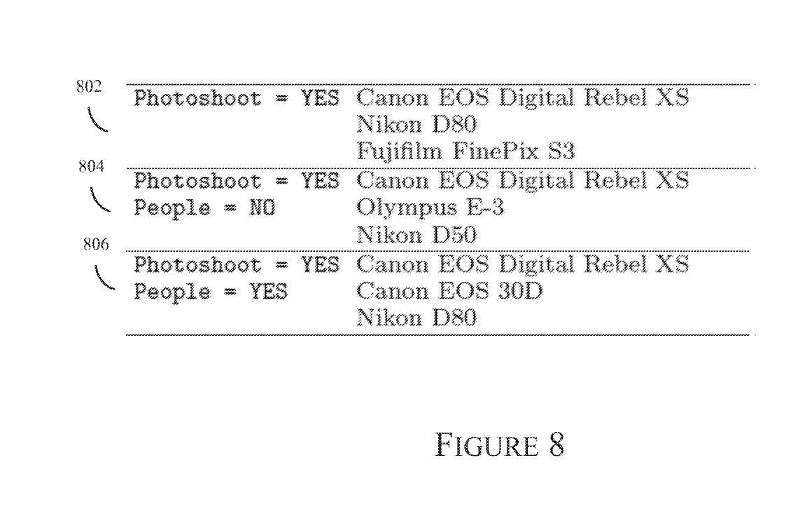

FIG. 8 provide some examples of recommendations associated with various portions of the flowchart of FIG. 7 in accordance with one or more embodiments of the present disclosure. By way of a non-limiting example, one of the top cameras recommended to the user in recommendations 806 is the Canon EOS 30D, which introduces an auto image rotation featuring to make better use of the LCD display especially during portrait-oriented shots. Recommendations 806 is associated with node 718, and users that indicated that they were interested in using the camera for photo-shots of people. For the user looking for a camera for shooting events and not people, e.g. users who responded no at node 714, an Olympus E-3 is recommended, which happens to be a lightweight digital SLR camera. The prominent presence of the Canon EOS Digital rebel XS in all three recommendations 802, 804 and 806 indicates its popular usage by users in the training data set.

In accordance with one or more embodiments, a novel recommender system is provided, which facilitates a user's shopping experience, e.g., shopping for products, such as without limitation technical products on an e-commerce website. In accordance with one or more such embodiments, a flowchart is learned, which flowchart contains questions, e.g., questions that are geared for non-expert users and/or for users that need not have any technical expertise about the product(s) for which the user is shopping. Embodiments of the present disclosure elicit questions designed using attributes selected from the user attribute, or feature, space, which includes information about users including without limitation user preferences, demographics, life-style preferences, interests, etc. rather than a product feature space, which includes product attributes, such as without limitation technical attributes of products.

In accordance with one or more embodiments, the flowchart is automatically built using training data, each node in the flowchart has an associated question and a ranking of products. The user follows the path along the flowchart by answering questions, and the user may stop at any point along the flowchart and receive a set of recommendations, which set of recommendations may comprise an ordered list of the top-k ranked products. In accordance with one or more embodiments, a tool is provided that facilitates a user's shopping experience, which tool comprises an advisor flowchart which may be modeled as a decision tree, which may be generated using a top-down approach used in building decision trees.

In accordance with one or more embodiments, at each node of an advisor flowchart, a set of suitable recommendations may be produced, so that the user may stop answering questions at any time in the process. In accordance with one or more such embodiments, a learning-to-ranked approach may be used to provide a list of top-k recommendations for the user given the current node at which the user is positioned, which position may be based on answers provided by the user to questions provided to the user at one or more nodes previously encountered by the user. Such an approach allows for a framework that implicitly leverages correlations between user preferences and product attributes, thereby providing a solution for the typical cold-start problems found in pure collaborative filtering. It further provides a simple way to interpret recommendations.

One or more embodiments provide a mixture of collaborative filtering, learning-to-rank, and interactive eliciting of user preferences.

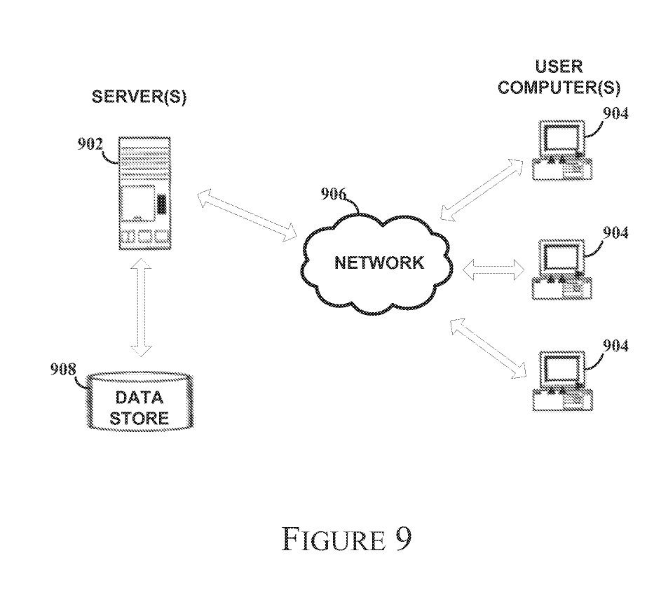

FIG. 9 illustrates some components that can be used in connection with one or more embodiments of the present disclosure. In accordance with one or more embodiments of the present disclosure, one or more computing devices, e.g., one or more servers, user devices or other computing device, are configured to comprise functionality described herein. For example, a computing device 902 can be configured to execute program code, instructions, etc. to provide functionality in accordance with one or more embodiments of the present disclosure.

Computing device 902 can serve content to user computing devices 904 using a browser application via a network 906. Data store 908, which can be used to store program code to configure a server 902 to execute functionality in accordance with one or more embodiments of the present disclosure.

The user computing device 904, can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 902 and the user computing device 904 can include one or more processors, memory, a removable media reader, network interface, display and interface, and one or more input devices, e.g., keyboard, keypad, mouse, etc. and input device interface, for example. One skilled in the art will recognize that server 902 and user computing device 904 may be configured in many different ways and implemented using many different combinations of hardware, software, or firmware.

In accordance with one or more embodiments, a computing device 902 can make a user interface available to a user computing device 904 via the network 906. The user interface made available to the user computing device 904 can include content items, or identifiers (e.g., URLs) selected for the user interface in accordance with one or more embodiments of the present invention. In accordance with one or more embodiments, computing device 902 makes a user interface available to a user computing device 904 by communicating a definition of the user interface to the user computing device 904 via the network 906. The user interface definition can be specified using any of a number of languages, including without limitation a markup language such as Hypertext Markup Language, scripts, applets and the like. The user interface definition can be processed by an application executing on the user computing device 904, such as a browser application, to output the user interface on a display coupled, e.g., a display directly or indirectly connected, to the user computing device 904.

In an embodiment the network 906 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

As discussed, a network may couple devices so that communications may be exchanged, such as between a server computing device and a client computing device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

It should be apparent that embodiments of the present disclosure can be implemented in a client-server environment such as that shown in FIG. 9. Alternatively, embodiments of the present disclosure can be implemented with other environments. As one non-limiting example, a peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

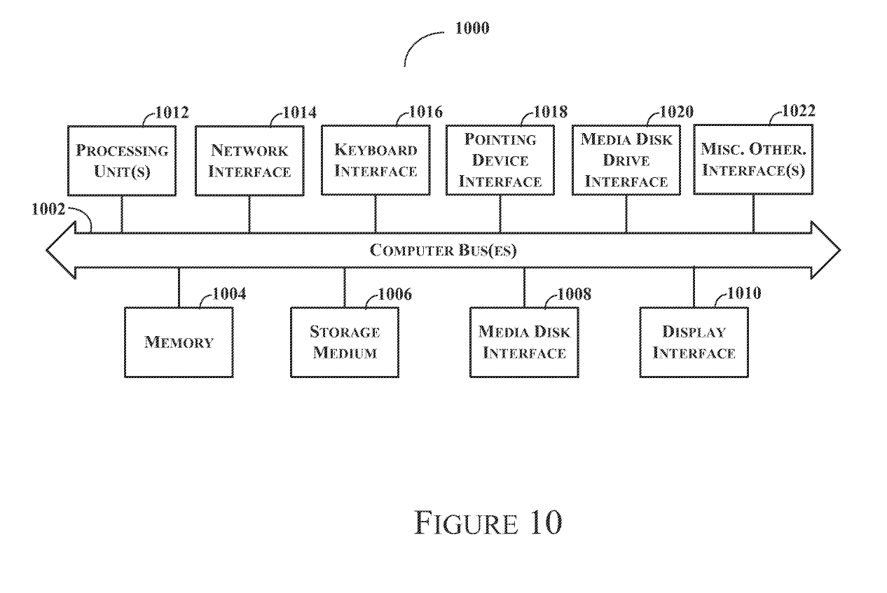

FIG. 10 is a detailed block diagram illustrating an internal architecture of a computing device, e.g., a computing device such as server 902 or user computing device 904, in accordance with one or more embodiments of the present disclosure. As shown in FIG. 10, internal architecture 1000 includes one or more processing units, processors, or processing cores, (also referred to herein as CPUs) 1012, which interface with at least one computer bus 1002. Also interfacing with computer bus 1002 are computer-readable medium, or media, 1006, network interface 1014, memory 1004, e.g., random access memory (RAM), run-time transient memory, read only memory (ROM), etc., media disk drive interface 1020 as an interface for a drive that can read and/or write to media including removable media such as floppy, CD-ROM, DVD, etc. media, display interface 1010 as interface for a monitor or other display device, keyboard interface 1016 as interface for a keyboard, pointing device interface 1018 as an interface for a mouse or other pointing device, and miscellaneous other interfaces not shown individually, such as parallel and serial port interfaces, a universal serial bus (USB) interface, and the like.

Memory 1004 interfaces with computer bus 1002 so as to provide information stored in memory 1004 to CPU 1012 during execution of software programs such as an operating system, application programs, device drivers, and software modules that comprise program code, and/or computer-executable process steps, incorporating functionality described herein, e.g., one or more of process flows described herein. CPU 1012 first loads computer-executable process steps from storage, e.g., memory 1004, computer-readable storage medium/media 1006, removable media drive, and/or other storage device. CPU 1012 can then execute the stored process steps in order to execute the loaded computer-executable process steps. Stored data, e.g., data stored by a storage device, can be accessed by CPU 1012 during the execution of computer-executable process steps.

Persistent storage, e.g., medium/media 1006, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
building, using at least one computer system, an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users;
identifying a set of product recommendations for a user using the advisor flowchart, the at least one computer:
traversing the advisor flowchart from a current node to a next node based on an answer received from the user in response to a question formed from the user attribute associated with the current node of the advisor flowchart;
wherein the set of product recommendations comprises a number of top-ranked products from the ranking of products associated with a user-selectable end node of the advisor flowchart.

2. The method of claim 1, wherein the end node is a leaf node of the advisor flowchart.

3. The method of claim 1, wherein the end node is an internal node of the advisor flowchart.

4. The method of claim 1, wherein each node of the advisor flowchart splits a set of users associated with the node into first and second sets of users, the first set of users comprising users that match the user attribute associated with node and the second set of users that do not match the user attribute associated with the node, wherein the question associated with the node is designed to elicit a response used to determine whether or not the user matches the user attribute associated with the current node.

5. The method of claim 1, the plurality of user attributes in the user space comprising user lifestyle, interest and demographic user attributes.

6. The method of claim 1, the product space comprising a plurality of products and a plurality of product attributes.

7. The method of claim 1, the advisor flowchart comprising a binary tree-shaped flowchart.

8. The method of claim 1, the training data comprising a user data store, a product data store and a user reviews data store, the user data store comprising a plurality of user attributes, the product data store comprising a plurality of product attributes and the user reviews data store associating a given user from the user data store, a given product from the product data store and a review of the given product provided by the given user.

9. A system comprising:
at least one computing device comprising one or more processors to execute and memory to store instructions to:
build an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users;
identify a set of product recommendations for a user using the advisor flowchart, the instructions to identify comprising instructions to:
traverse the advisor flowchart from a current node to a next node based on an answer received from the user in response to a question formed from the user attribute associated with the current node of the advisor flowchart;
wherein the set of product recommendations comprises a number of top-ranked products from the ranking of products associated with a user-selectable end node of the advisor flowchart.

10. The system of claim 9, wherein the end node is a leaf node of the advisor flowchart.

11. The system of claim 9, wherein the end node is an internal node of the advisor flowchart.

12. The system of claim 9, wherein each node of the advisor flowchart splits a set of users associated with the node into first and second sets of users, the first set of users comprising users that match the user attribute associated with node and the second set of users that do not match the user attribute associated with the node, wherein the question associated with the node is designed to elicit a response used to determine whether or not the user matches the user attribute associated with the current node.

13. The system of claim 9, the plurality of user attributes in the user space comprising user lifestyle, interest and demographic user attributes.

14. The system of claim 9, the product space comprising a plurality of products and a plurality of product attributes.

15. The system of claim 9, the advisor flowchart comprising a binary tree-shaped flowchart.

16. The system of claim 9, the training data comprising a user data store, a product data store and a user reviews data store, the user data store comprising a plurality of user attributes, the product data store comprising a plurality of product attributes and the user reviews data store associating a given user from the user data store, a given product from the product data store and a review of the given product provided by the given user.

17. A computer readable non-transitory storage medium for tangibly storing thereon computer readable instructions that when executed cause at least one processor to:
build an advisor flowchart, the flowchart comprising a plurality of nodes, each node of the plurality having an associated user attribute selected from a plurality of user attributes that form a user space and each node having an associated ranking of products in a product space, the advisor flowchart being built using training data comprising data about a plurality of users and a plurality of products associated with the plurality of users;
identify a set of product recommendations for a user using the advisor flowchart, the instructions to identify comprising instructions to:
traverse the advisor flowchart from a current node to a next node based on an answer received from the user in response to a question formed from the user attribute associated with the current node of the advisor flowchart;
wherein the set of product recommendations comprises a number of top-ranked products from the ranking of products associated with a user-selectable end node of the advisor flowchart.

18. The computer readable non-transitory storage medium of claim 17, wherein the end node is a leaf node of the advisor flowchart.

19. The computer readable non-transitory storage medium of claim 17, wherein the end node is an internal node of the advisor flowchart.

20. The computer readable non-transitory storage medium of claim 17, wherein each node of the advisor flowchart splits a set of users associated with the node into first and second sets of users, the first set of users comprising users that match the user attribute associated with node and the second set of users that do not match the user attribute associated with the node, wherein the question associated with the node is designed to elicit a response used to determine whether or not the user matches the user attribute associated with the current node.

21. The computer readable non-transitory storage medium of claim 17, the plurality of user attributes in the user space comprising user lifestyle, interest and demographic user attributes.

22. The computer readable non-transitory storage medium of claim 17, the product space comprising a plurality of products and a plurality of product attributes.

23. The computer readable non-transitory storage medium of claim 17, the advisor flowchart comprising a binary tree-shaped flowchart.

24. The computer readable non-transitory storage medium of claim 17, the training data comprising a user data store, a product data store and a user reviews data store, the user data store comprising a plurality of user attributes, the product data store comprising a plurality of product attributes and the user reviews data store associating a given user from the user data store, a given product from the product data store and a review of the given product provided by the given user.
